(19) United States
(12) Patent Application Publication
(10) Pub. No.: US 2007/0150082 A1
(43) Pub. Date: Jun. 28, 2007

(54) Method, mechanism, implementation, and system of real time listen-sing-record STAR karaoke entertainment (STAR "Sing Through And Record")

(75) Inventors: Shu-Ting Yang, Cerritos, CA (US); Charles Hsu, McLean, VA (US)

Correspondence Address: REED SMITH LLP, Suite 1400, 3110 Fairview Park Drive, Falls Church, VA, 22042, US

(73) Assignee: Avera Technology Ltd.

(21) Appl. No.: 11/400,277

(22) Filed: Apr. 10, 2006

Related U.S. Application Data
(60) Provisional application No. 60/753,746, filed on Dec. 27, 2005.

(30) Foreign Application Priority Data
Feb. 24, 2006 (CN) 200620055602.8

(51) Int. Cl. G06F 17/00; H04B 1/00

(52) U.S. Cl. 700/94; 381/119

(57) ABSTRACT

A hand-held audio mixing device includes an I/O interface, an AD/DA converter, a dual-direction codec which sample rate is set in 8-48 KHz with a 16-bit resolution, an MCU, a memory, and an operational amplifier. The device executes a first process that the I/O interface receives a first source of analog audio signals, and the amplifier amplifies the received signals thereby playing the amplified signals to a user. The device executes a second process that the I/O interface receives a second source of analog audio signals, the converter mixes the received second source of signals with the amplified first source of signals into an analog mixture, the converter converts the analog mixture into digital mixture signals, the codec compresses the digital mixture signals, and the memory saves the compressed signals. The first and second processes are executed substantially simultaneously such that there is no latency delay perceivable by the user.

### BACKGROUND OF THE INVENTION

This application claims the benefit of U.S. Provisional Patent Applications Ser. No. 60/753,746 filed on Dec. 27, 2005, an the Chinese Patent App. No. 200620055602.8 filed on Feb. 24, 2006, the entire disclosures of which are incorporated herein by reference.

### FIELD OF THE INVENTION

The present invention relates to a hand-held karaoke device which substantially simultaneously plays a music and records the voice of a singer with the music as background, and then stores the recording.

### DESCRIPTION OF THE RELATED ART

Karaoke (in Japanese, kara means “empty”, and oke means “orchestra”) is a form of entertainment in which an amateur singer or singers sing along with recorded music on microphone. The music is typically of a pop song in which the voice of the original singer is absent or reduced in volume. It involves using a karaoke machine which provides the backing track and display the words/lyrics on a screen, sometimes including color changes synchronized with the music, on music video to guide the sing-along. A karaoke system is popular for business people to provide a social platform of business engagement and connection. Furthermore, karaoke is highly accepted by families for entertainment and relaxing. A karaoke system is also used for children and youths in support of the enhancement of creative power and thinking power. A karaoke system includes a main unit connected to a display unit through wire or wireless transmission. The main unit, which is basically a music storage medium (e.g. a CD), feeds the display unit with image and music data embedded the words or subtitles of a music piece on the display unit. The users can sing and accompany under the background music with the corresponding words of the songs. By adjusting the background music and manipulating the pitch, echo/reverb of the input form the microphone, anyone can sound like a star. Thus, karaoke becomes a popular amusement with people of different ages and sexes. The karaoke equipment market experiences fierce competition in order to provide new features and models to the public.

Currently, there are several types of the Karaoke systems in the market. They can be categorized into a low-end Karaoke model, a single Karaoke set, and a combinational Karaoke system. The major features and introduction are described as follows.
(1). The low-end Karaoke mode is a simple and easy-to-use Karaoke model. It does not perform well due to its low-cost and simple features. This model usually does not come with the microphone, and it requires to connect to a power amplifier to play the songs.
(2). The single Karaoke set is a higher level device to support most of the karaoke functions. It can adjust the tone of the microphone in support of the quality of vocal music and it also provides higher power amplifier, which can cover all the audio frequency response (20˜20 k Hz) without any quality distortion. For example, a portable all-in-one player that typically contains such features as: a CD player which has CDG capability, a microphone, a built in speaker, a cassette tape player (which allows the user to record both the CDG background music and the user's voice using the microphone), a video connector which allows the user to connect the player to a home TV (via a yellow RCA connector or an RF modulator), a pitch controller, an echo/reverb controller, and an external speaker jack (to play the music through a more amplified component system). Portable Karaoke Players play both audio CDs and the CDG Karaoke discs, but most do not play Video CD (VCDs) or DVDs.
(3). The combinational Karaoke system is a professional entertainment system, which can provide multiple entertainment functions including the integration of the internet and computers. This feature of the internet and computer provides a platform for users to share and exchange the karaoke data. It also can connect to the home theatre system and sing on a stage at home.

In Asia, a Karaoke box (also called KTV) is the most popular type of karaoke venue. A karaoke box is a small or medium-sized room containing karaoke equipment for a group of friends to rent by timed increments, providing for a more intimate and less public atmosphere. Generally, entire businesses provide karaoke as their primary function, although karaoke machines are sometimes included in hotel or other business facilities. In a KTV, the music quality is heavily dependent on the stereo system. And the karaoke system usually consists of three major parts including a karaoke device, microphone, and speakers. In a good karaoke system, not only the performance of every single part is critical, but also the operation and integration among these three parts in the system. It is well known that a karaoke system is composed of pre-stage circuit, a mixer system, and an amplifier circuit in support of the multiple functions such as a dynamic echo performance, music quality selection in terms of treble, bass, and balance, and operational amplification of volume. The functional block diagram is depicted in FIG. 1. An FET (filed effect translator) audio mixer can be used to mix the audio signals from a pre-stage circuit and a microphone to provide more dynamic and full range music response. This simple circuit mixes two or more channels into one channel and consumes very little power. In any sound system, ultimate quality depends on the speakers. The best recording, encoded on the most advanced storage device and played by a top-of-the-line deck and amplifier, will sound awful if the system is hooked up to poor speakers. In good loudspeaker systems, the speaker crossovers and enclosures must be carefully designed and selected. Active crossovers are electronic devices that pick out the different frequency ranges in an audio signal before it goes on to the amplifier. A condenser microphone is widely used in the karaoke system. The condenser microphone is essentially a capacitor, with one plate of the capacitor moving in response to sound waves. The movement changes the capacitance of the capacitor, and these changes are amplified to create a measurable signal. Condenser microphones usually need a small battery to provide a voltage across the capacitor. The balance among the pre-stage circuit, the mixers, and the speakers are important to provide the perfect music quality.

Most Karaoke systems only provide the functions of singing and listening. The recording function of the digital music costs highly and it is difficult to implement, which is done by a, DJ, an sound engineer, or a recording engineer in professional sound recording, audio editing and sound systems to balance the relative volume and frequency content of a number of sound sources. Typically, these sound sources are the different musical instruments in a band or vocalists, the sections of an orchestra and so on. The above-mentioned all-in-one player shares the same deficiencies of a recordable karaoke system described in Chinese Pat. No. ZL 02137374.4. This system uses a specific digital process to compress digital audio signals for recording. However, the technology used is Adaptive Differential (or Delta) Pulse Code Modulation (ADPCM). Pulse-code modulation (PCM) is a digital representation of an analog signal where the magnitude of the signal is sampled regularly at uniform intervals, then quantized to a series of symbols in a digital (usually binary) code. PCM is used in digital telephone systems and is also the standard form for digital audio in computers and various compact disc formats, as well as a standard in digital video. Differential (or Delta) pulse-code modulation (DPCM) encodes the PCM values as differences between the current and the previous value. For audio this type of encoding reduces the number of bits required per sample by about 25% compared to PCM. Adaptive DPCM (ADPCM) is a variant of DPCM that varies the size of the quantization step, to allow further reduction of the required bandwidth for a given signal-to-noise ratio (SNR or S/N). ADPCM codecs are waveform codecs to quantize the difference between the speech signal and a prediction that has been made of the speech signal. If the prediction is accurate then the difference between the real and predicted speech samples will have a lower variance than the real speech samples, and will be accurately quantized with fewer bits than would be needed to quantize the original speech samples. Theoretically, ADPCM was designed for voice compression and is not appropriate for the music and audio compression. As such, a mixing of music and voice using ADPCM provides bad quality of mixture. Another major drawback is the long latency delay. This latency delay prevents the karaoke system from mixing music with voice in real time. Additionally, the sample rate of ADPCM is designed at 8 K Hz, which can not support good music quality as CDs (the sample rate of CD quality is 44.1 KHz).

Based on the description on FIG. 1, in general the conventional karaoke system does not have (1) a digital microphone to record in real time; and (2) any digital memory devices to store the music and voice mixture in real time.

There is a demand for a real-time Sing-Listen-Record STAR Karaoke system which is low-cost, compact, low-power, and hand-held. Such a system shall provide the functions of singing, listening and recording, as well as being integrated with computers and internet to access and manipulate multimedia data. Further more, the system shall easily convert analog signals to digital signals, and download/upload the digital data from/to internet to expand the entertainment worldwide.

### SUMMARY OF INVENTION

The present invention (STAR) is a high-quality, low-cost, low-power, and portable karaoke system. STAR is an object of the present invention to provide a karaoke system, which is capable of creating significant values added.

It is another object of the present invention to provide a karaoke system, which can be conveniently used by children and/or youth. Furthermore, one more object of the STAR is to expand the karaoke system into the language education aided system.

The present invention provides a very compact karaoke device, not only to support the features of singing, listening, and recording, but also to support all the manipulation of computers, including the data transfer such as download and upload.

The STAR system is a real-time and dual-direction karaoke system to perform singing, playing and recording simultaneously including the audio I/O connection and the operational amplifier. The major audio process between the audio input device and the amplifier includes the dual-direction audio JPEG2000 codec, the AD/DA CONVERTER, the MCU, the memory storage device, and their circuitry connection. The internal and external memory storage devices are connected to the dual-direction audio JPEG2000 codec and the MCU.

Another novel development in this invention is to use an external memory device such as SD, memory stick, and MMC cards, which is convenient for data exchange and sharing. In addition, an internal memory device is also included in the STAR system, which can be connected to computer through the USB interface.

### BRIEF DESCRIPTION OF THE DRAWINGS

The advantages of the present invention will become apparent to one of ordinary skill in the art when the following description of the preferred embodiments of the invention is taken into consideration with accompanying drawings where like numerals refer to like or equivalent parts and in which:

FIG. 1 is a functional block diagram of a conventional karaoke system

FIG. 2 shows a functional block diagram of one embodiment of an STAR system according to the invention.

FIG. 3 depicts a block diagram of the digital audio input design according to the invention.

FIG. 4 expresses q block diagram of the analog audio input design according to the invention.

FIG. 5 illustrates a block diagram of the audio output design according to the invention.

FIG. 6 demonstrates a connection of the STAR system to a computer and the internet.

FIG. 7 shows a first application of the STAR system using a microphone.

FIG. 8 shows a second application of the audio input of the STAR system using a microphone and music player.

FIG. 9 shows a third application of the audio input of the STAR system using a microphone and the external memory storage device.

FIG. 10 shows a fourth application of the audio input of the STAR system using a microphone and just the internal memory storage device.

FIG. 11 depicts a physical embodiment of a hand-held STAR device.

FIG. 12A shows a perspective view of the STAR device of FIG. 11; FIG. 12B shows a control surface of the START device; FIG. 12C shows a blue print design of the START device of the microphone surface and side surfaces.

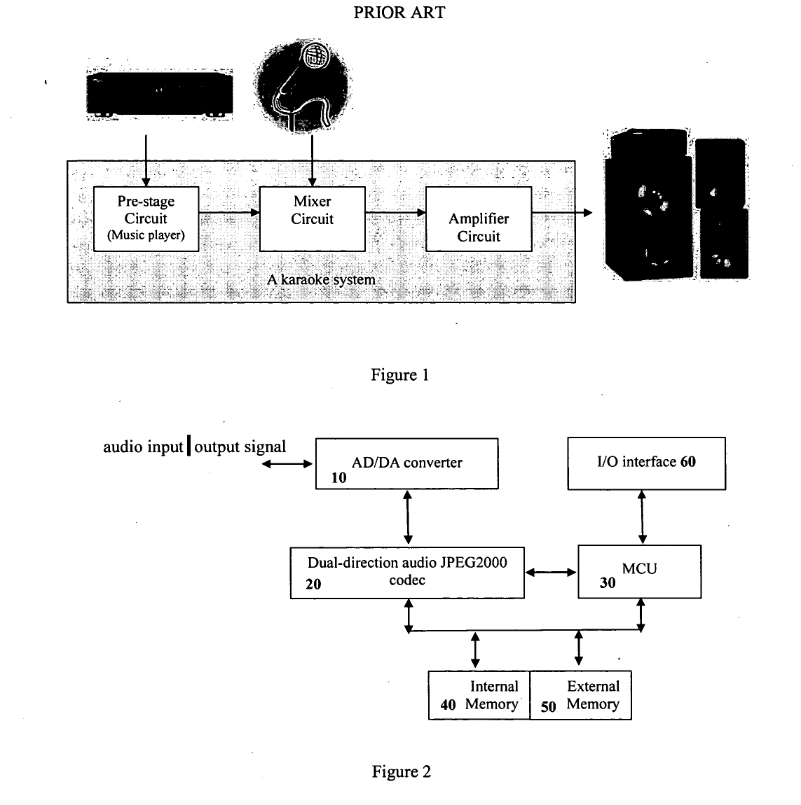

### DETAILED DESCRIPTION OF THE PREFERRED EMBODIMENTS

With reference to the figures, like reference characters will be used to indicate like elements throughout the several embodiments and views thereof. The procedures implemented by the STAR system to provide a total solution for a real-time listening, singing, and recording karaoke system is showed as follows. The JPEG2000 standard is used as an example, other audio data compression standards, such as MP3, can also be adopted with supporting hardware and software.

JPEG 2000 is a wavelet-based image compression standard. It was created by the Joint Photographic Experts Group committee. JPEG 2000 operates at higher compression ratios without generating the characteristic ‘blocky and blurry’ artifacts of the original DCT-based JPEG standard. Part of JPEG 2000 has been published as an ISO standard, ISO/IEC 15444-1:2000. JPEG 2000 is not yet widely supported in web browsers, and hence is not generally used on the World Wide Web.

The present invention employs lossless and high-efficiency JPEG2000 compression technology such that the real-time recordable karaoke can process dual functions of playing and recording simultaneously. The key technology used in the lossless and lossy JPEG2000 compression in the STAR system is Wavelet transform. Wavelets are mathematical functions that cut up data into different frequency components, and then study each component with a resolution matched to its scale. They have advantages over traditional Fourier methods in analyzing physical situations where the signal contains discontinuities and sharp spikes. This feature is helpful to some specific frequency response of music.

The method implemented by the STAR system to provide a total solution for a real-time listening, singing, and recording karaoke system is as follows:
(A). providing an integrate STAR karaoke system, which includes audio input devices, an analog/digital converter (AD/DA CONVERTER), a dual-direction audio codec using JPEG2000, an MCU (MicroController Unit), memory storage devices, an operational amplifier, and an audio/video display;
(B). transmitting a background music (analog or digital) and a users' voice into the AD/DA CONVERTER;
(C). generating digital data by the AD/DA CONVERTER based on commends from the MCU, and transmitting the digital data a into the dual-direction audio JPEG2000 codec;
(D). compressing the digital audio data by the dual-direction audio codec employing the JPEG2000 technology. The JPEG2000 can perform lossless and high-efficiency compression based on the application requirement; and
(E) Storing the compressed digital audio data in the memory storage device.
During a playing process, simultaneously, the MCU sends out commends to access the digital data in the memory storage device and transfer them into the dual-direction audio JPEG2000 codec. The digital compressed audio data will be decompressed and fed into the AD/DA CONVERTER. The AD/DA CONVERTER will convert the digital data into the analog signal and then feed the analog signals to the operational amplifier and the audio/video display.

In Step A, a portable and external memory storage device can be inserted to expand the applications of the karaoke systems. The digital compressed data after the dual-direction audio JPEG2000 codec in procedure D can be stored into the external memory storage device based on the commend from the MCU. Similarly, the pre-recorded digital data in the external storage device can be read out and decompressed through the dual-direction audio JPEG2000 codec and then convert to the analog signals. The analog signals can mix with user's voices and then be compressed and stored back to the memory storage device. The internal and external memory storage devices employ the FAT16 (file allocation table) system to manage the digital data, which can be directly merged with the existing computer systems. The interconnection with a computer provides a platform to embed the karaoke data into existing multimedia data.

In Steps C and D, the AD/DA CONVERTER and the dual-direction audio JPEG2000 codec process the audio signals under the sampling rates from 20 KHz to 48 KHz (typical for computer use). And the AD/DA CONVERTER can provide 8-bit and 16-bit two different resolutions in support of various applications.

As shown in FIG. 2, a STAR karaoke system according to the invention includes audio input devices 100, an analog/digital & digital/analog converter (AD/DA C) 10, a dual-direction audio codec using JPEG2000 20, an MCU (MicroController Unit) 30, an internal memory storage device 40, a external memory storage device 50, an I/O interface 60, an operational amplifier 200, and an audio/video display. The background music (analog or digital) and the users' voice are fed into the audio input device 100 and then transferred into the AD/DA CONVERTER 10. The AD/DA CONVERTER 10 starts to generate the digital data based on the commends from the MCU 30, and then the digital data are fed into the dual-direction audio JPEG2000 codec 20. The dual-direction audio codec 20 employs the JPEG2000 technology to compress the digital audio data and store into the memory storage device 40. The JPEG2000 can perform lossless and high-efficiency compression based on the application requirement. Once the digital audio data is compressed, it will be stored in the memory storage device 40. Simultaneously, the MCU 30 will send out the commends to access the digital data in the memory storage device 40 and transfer them into the dual-direction audio JPEG2000 codec 20. The digital compressed audio data will be decompressed and fed into the AD/DA CONVERTER 10. The AD/DA CONVERTER 10 will convert the digital data into the analog signal and then feed the analog signals to the operational amplifier 200 and the audio/video display.

The AD/DA CONVERTER 10 can be any electronic device that converts a voltage to a binary digital number. Some non-electronic devices, such as shaft encoders, can also be used as the AD/DA CONVERTER 10. Commercial analog-to-digital converters are usually integrated circuits. Commercial AD/DA Converters often have several inputs that feed the same converter, usually through an analog multiplexer. Different models of AD/DA CONVERTER may include sample and hold circuits, instrumentation amplifiers or differential inputs, where the quantity measured is the difference between two voltages.

The dual-direction audio JPEG2000 codec 20 is the key component in this invention. A Codec is a device or program capable of performing Encoding and Decoding on a data stream or signal. The word “codec” is a portmanteau of any of the following: ‘Compressor-Decompressor’, ‘Coder-Decoder’, or ‘Compression/Decompression algorithm’. The dual-direction audio JPEG2000 codec 20 can compress and decompress the audio signals in real time. It also can process not only the music data but also the voice signals. Furthermore, the dual-direction audio JPEG2000 codec 20 provides a variety of compression bit rates from lossless to highly compression. Additionally, it can process the audio signals under different resolutions. And it performs without any significant latency delay. The dual-direction audio JPEG2000 codec can be implemented via software, hardware or a combination thereof. Preferably, the dual-direction audio JPEG2000 codec 20 is implemented via the hardware described in U.S. patent application Ser. No. 11/114,200 entitled “System And Method For Audio Data Compression And Decompression Using Discrete Wavelet Transform (DWT)” of Huang et al., the entire disclosures of which are incorporated herein by reference.

MicroController Unit (MCU) 30 shown in FIG. 2 controls the data flow and the operations of the STAR system. The operations include play, record, stop, fast forward, fast backward, power on/off, selection of voice mode and music mode, selection of the quality, erase, delete, format, LCD display function and other functions. It also provides the driver and function to control the LCD display. Power on and off can be switched via the MCU 30 as well. In addition, it also can indicate the situation of the rechargeable battery. Optionally, a RF module is embedded in the MCU 30 to support a radio frequency wireless transmission. In order to reduce the implementation cost, an 8-bit MCU 30 is preferred in the STAR system. However, any type of MCU 30 can be used to enhance the STAR performance. MCU is a single chip that contains a processor, RAM, ROM, clock and I/O control unit. Hundreds of millions of MCUs are used in myriad devices ranging from automobiles to action figures.

The internal memory 40 device and the external memory device 50 store the music and voice data in the STAR system. A flash memory is integrated within the STAR system of this invention as the internal memory 40 for users to manipulate the audio processing. The storage size of the flash memory can be easily adjusted by the system based on the users' requirement. The external memory device 50 is used to store and plat the specific contents, which can be private data and information or commercial content data provided by specific publishers. The external memory device 50, such as a Secure Digital (SD) card, a memory stick, a SmartMedia (SM) card, and a Multimedia Card (MMC), can be used as the secondary memory device. All the data stored in the internal memory device 40 and the external device 50 can be easily transferred (upload and download) via a computer or the internet.

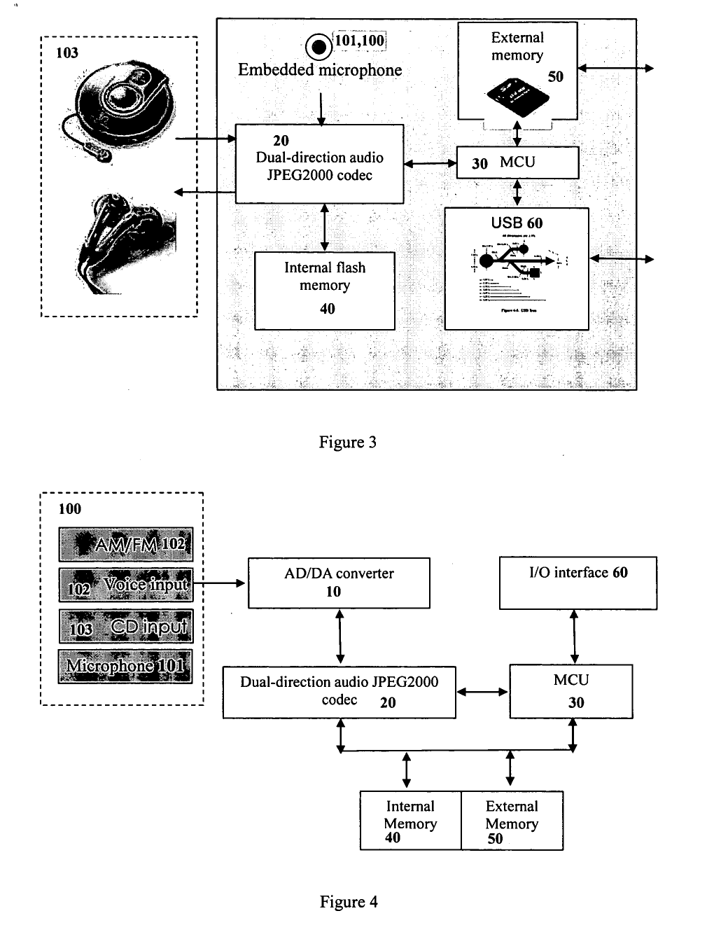

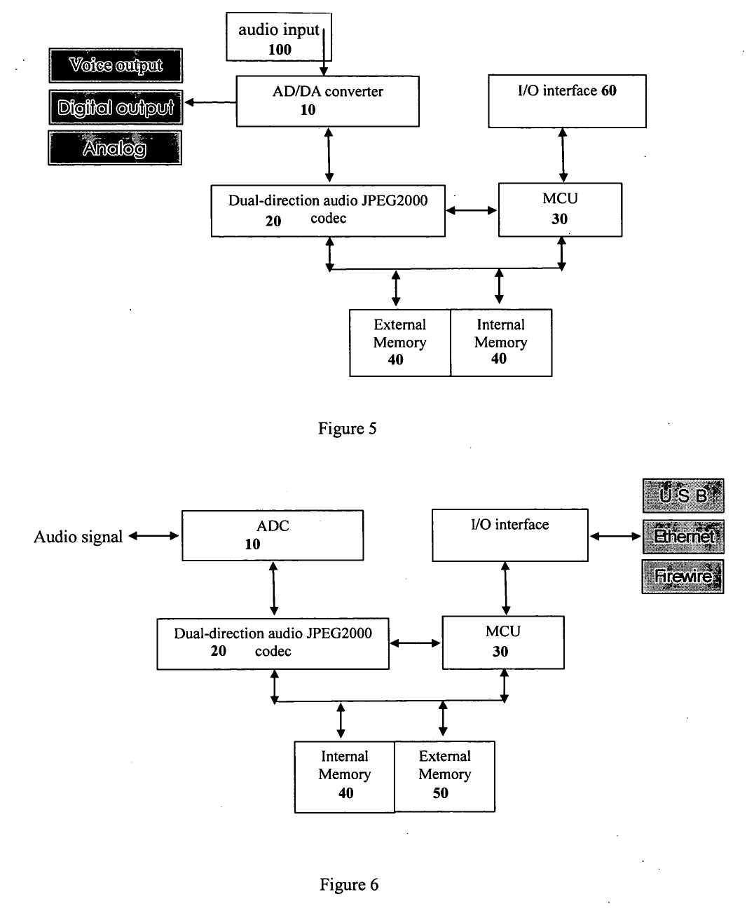

As shown in FIG. 3, the STAR system processes a variety of audio input sources 100 including a stereo audio signal from an FM receiver or a mono audio signal from an AM receiver, a human voice directly from a high-performance microphone 101, a CD quality music directly plugged in from a CD player 103, and one set of the line-in jack for other audio sources. The operation of the audio input source to the STAR is depicted in FIG. 4. The output of the STAR system can be analog signals directly connected to speakers. The output speaker can play both voice and music analog signals. Optionally, another digital output terminal is also provided in FIG. 5. The I/O interface 60 supports USB, Ethernet, and firewire connections in FIG. 6. The USB connection supports transmitting the data in and out to personal computers. The Ethernet connections supports the feasibility to access the internet in support of the data and entertainment sharing without accessing computers. Firewire connections help for high efficient transmission. FireWire (also known as i.Link or IEEE 1394) is a personal computer (and digital audio/video) serial bus interface standard, offering high-speed communications and isochronous real-time data services. FireWire has replaced SCSI in many applications due to lower implementation costs and a simplified and more adaptable cabling system. Almost all modern digital camcorders have included this connection since 1995. Many computers intended for home or professional audio/video use have built-in FireWire ports. These transmission mechanisms are illustrated in the I/O interface of the STAR system of the invention in FIG. 4.

The STAR system may wirelessly communicates with a PC or a MIDI device to import or export a MIDI file or a MIDI-Karaoke (which uses the “.kar” file extension) file. An exported MIDI file may be just the signer's voice or the combination of the signer's voice with the background music. A MIDI-Karaoke file is an “unofficial” extension of MIDI files, used to add synchronized lyrics to standard MIDI files. These often display the lyrics synchronized with the music in “follow-the-bouncing-ball” fashion, essentially turning any PC into a Karaoke machine.

The STAR system provides four new advantages: (1) Digital design: digital data has several advantages such as easy maintenance and management. Digital data makes the data exchange and sharing. And the digital data can be mass produced. If the digital data is carefully coded, it can be well protected to preserve the copyright. The major key point of the digital data is for cost reduction during the production. (2) Dual-direction audio JPEG2000 codec: the dual-direction audio JPEG2000 codec can compress and decompress the digital audio data simultaneously. It can process the CD quality music, but also compress the voice signals. In addition, the dual-direction audio JPEG2000 codec can perform lossless and high-efficiency compression. Furthermore, it can compress the audio signals under various sampling rates. The key point is that it does not have long latency delay during the processing. (3) Memory storage device: internal and external memory storage devices are used to store the digital music and voice data. The volume of the memory storage can be changed based on the user's requirement. The audio data can be duplicated using these two internal and external memory storage devices. (4) Data transfer: USB is included in the present STAR system. The audio data can be transfer to/from computers through USB. Ethernet connection is also included in the present STAR system to access the internet in support of data sharing and exchange. In addition, firewire connection (IEEE1394) is embedded in the present STAR system to provide higher data transfer rate.

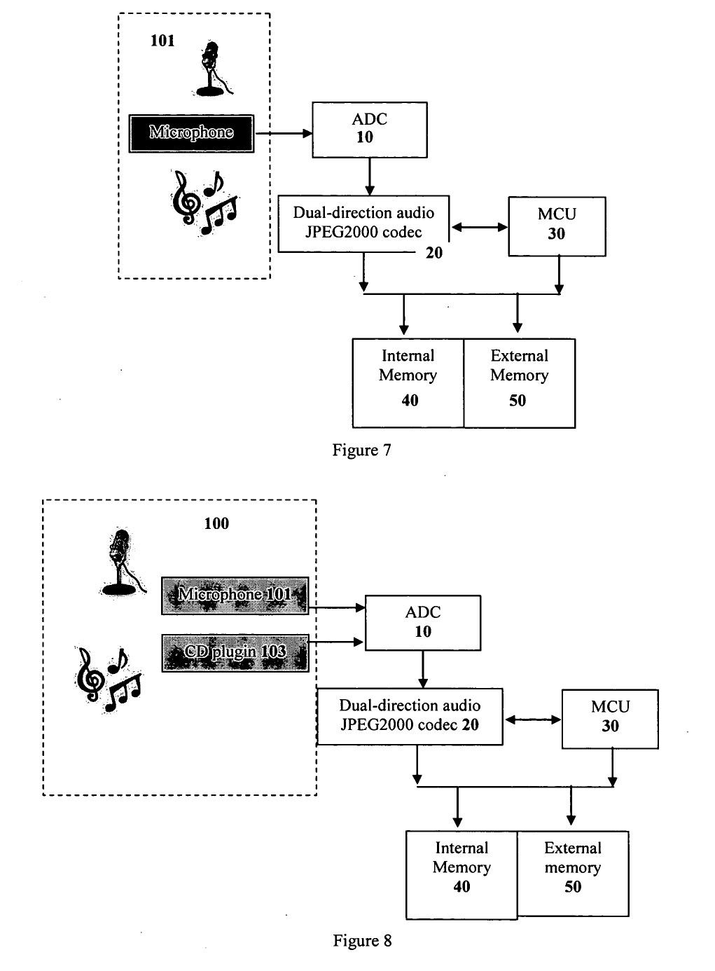

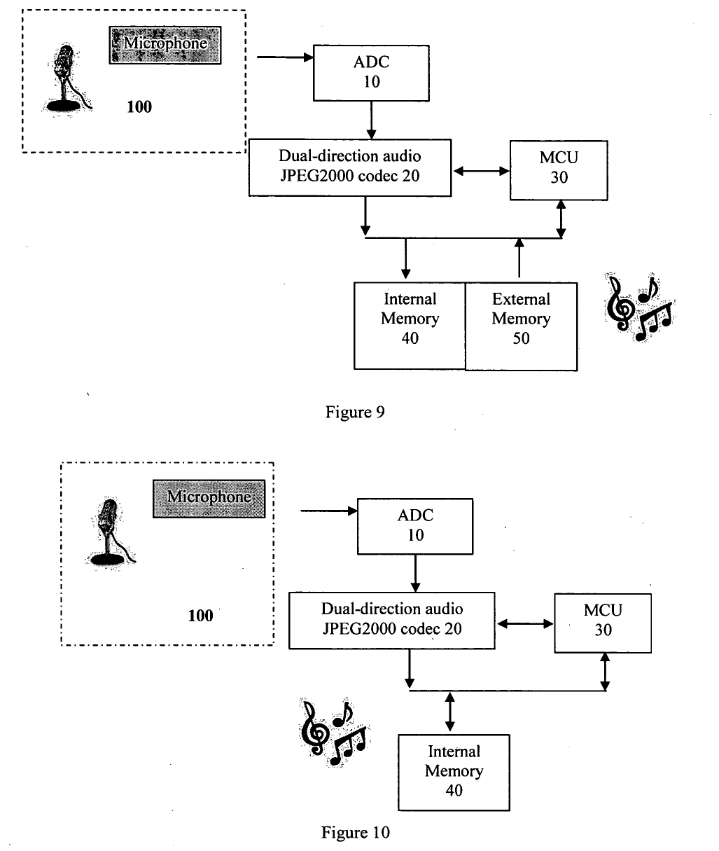

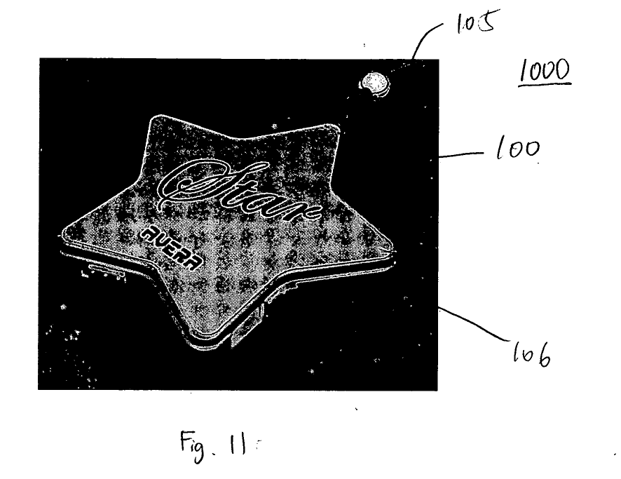

There are several different applications of the STAR system:
(1). The first application as depicted in FIG. 7 is to use the STAR system is to capture and record a user's voice and a background music (e.g., radio broadcast, concerts, etc, however, the user should obtain proper copyright licenses for using the music to generate such derivative works) simultaneously. It can record the live vocal/musical performance with the pre-recorded background music. The live performance or user's voice can be recorded using the embedded microphone or the external microphone 101 then the audio signals are digitalized and processed through the dual-direction audio JPEG2000 codec 20. The digital compressed data is then stored in the internal memory device 40 and/or the external memory device 50. In this application, it performs like a tape recorder except recording digital (rather than analog) data and storing the data in a memory device (rather than a tape).
(2). The second application as depicted in FIG. 8 is to use the STAR system to capture and record the user's voice through the embedded microphone or the external microphone 101. In particular, the background music is played by an external music players 103 (such as CD or DVD players, computer, MP3, and etc); meanwhile, the analog signals are transmitted from the CD, etc via the plug-in. The background music is carried in, mixed with the user's voice, and then processed through the dual-direction audio JPEG2000 codec 20, and then stored in the internal memory device 40 and/or the external memory device 50.
(3). The third application as depicted in FIG. 9 is to use the STAR system to employ the portable and external memory device 50 to store the pre-recorded music. The external memory device is directly inserted into the STAR system, and the data in the external memory 50 can be read out and decompressed. And then the decompressed data (through the dual-direction audio JPEG2000 codec 20) is converted into the analog audio signals via the AD/DA CONVERTER 10. The analog background music is mixed with the user's voice and then digitalized and compressed through the AD/DA CONVERTER 10 and the dual-direction audio JPEG2000 codec 20 respectively, and then stored in the internal memory 40.
(4). The fourth application as depicted in FIG. 10 is to use the STAR system to employ the internal memory device 40 to store the pre-recorded music. The pre-recorded music will be read out from the internal memory device 40, processed through the dual-direction audio JPEG2000 codec 20, converted via the AD/DA CONVERTER 10. The analog background music will be mixed with the user's voice and then digitalized and compressed through the AD/DA CONVERTER 10 and the dual-direction audio JPEG2000 codec 20 respectively, and then stored in the internal memory 40.

The described four applications of the STAR system can record a live vocal performance and/or a user's voice with a background music and/or a live musical performance, and store the mixture into a memory device. All the operations of each application are processed almost simultaneously such that the STAR system simultaneously plays the music and records the voice of a singer with the music as background, and stores the recording in a real time manner. The recording can be repeated until the performance and requirement is satisfied. The recording can be repeated until the user satisfies with the outcome. And the result can be deleted if user doesn't like it.

The third and fourth applications provides a standing-alone (self-sufficient), portable and compact karaoke device, since they do not require external musical sources. In the third and fourth applications are enabled by the dual-direction audio JPEG2000 codec which processes the compression and the decompression simultaneously without any critical latency delay.

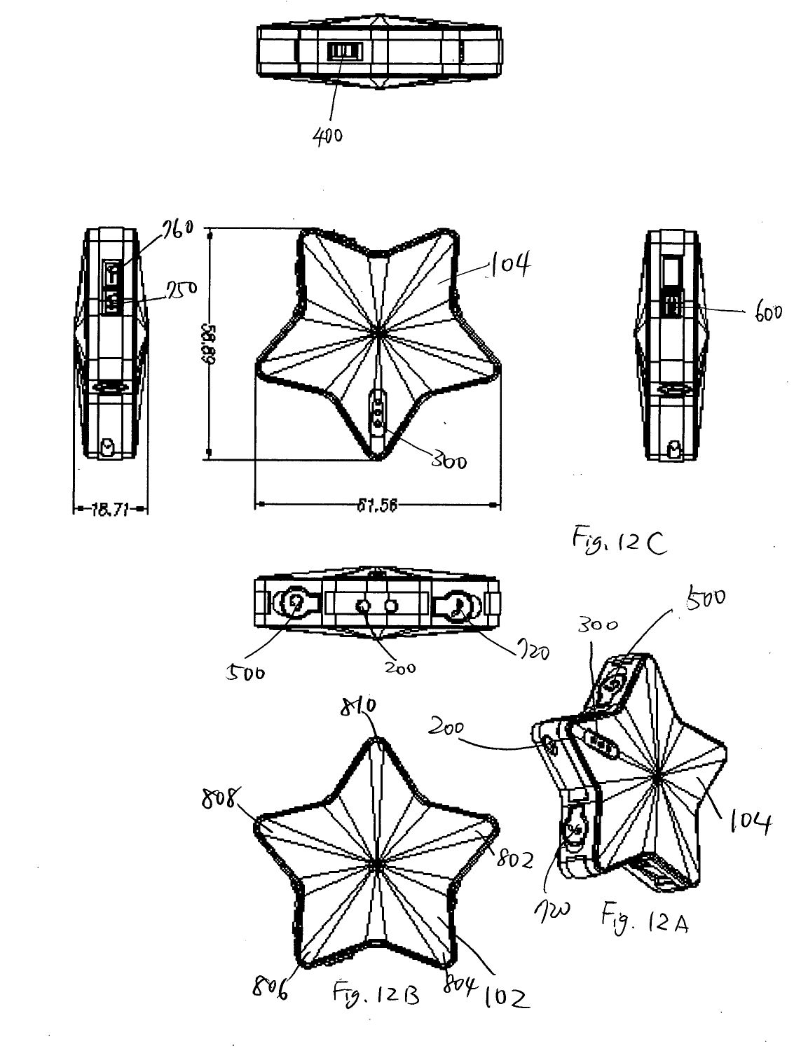

FIG. 11 shows a perspective view of a physical embodiment of the STAR system. This embodiment of a STAR held-held audio-mixing device 1000 has a star-shaped (⋆) body 100 with a control face 102, a microphone face 104 and five triangular side faces 106. FIG. 12A shows a hole 200 punching on one of the triangular side faces 106 for a string 105 to insert through. The star-shaped body 100 has five triangles 802, 804, 806, 808, 810 as shown in FIG. 12B. A built-in microphone 300 (FIG. 12C) is arranged on the microphone face 104 at the triangle 810. An ON/OFF switch 400 is arranged on the bottom side of the triangle 806, a plug 500 for inserting a cell-phone type earphone/microphone assembly is arranged upper side of the triangle 808, and a play ( [symbol] ) bottom 720 is arranged on the upper side of the triangle 802. An Increase Volume (V+) bottom 750 and a Reduce Volume (V−) bottom 760 are arranged on a side face of the triangle 806. The five triangles 802, 804, 806, 808, 810 on the control face 102 of the a star-shaped body 100 can be pressed by a user to perform the functions of Stop/Pause (□), Forward ( [symbol] ), Backward ( [symbol] ), etc. For example, rather than pressing the ON/OFF (∘) switch 400, a user can press once the control face 102 at the triangle 802 to turn on the device, press twice for stop the device, or continues pressing over 10 seconds to play a music. All kinds of combinations for arranging the functions on the five triangles are possible, and the various functions shall be printed on the triangles for user's convenience.

Alternatively, various connection terminals and control bottoms may be arranged on the five triangular side faces 106. For example, the Forward ( [symbol] ) bottom 740 and the Reduce Volume (V−) bottom 760 are on the side faces of the triangle 802, an ON/OFF (∘) switch 400 and a Stop/Pause (□) bottom 710 are on the side faces of the triangle 804, a plug 500 for inserting a cell-phone type earphone/microphone assembly and a play ( [symbol] ) bottom 720 are on the side faces of the triangle 806, a Backward ( [symbol] ) bottom 730 and a Increase Volume (V+) bottom 750 are on the side faces of the triangle 808, and an USB terminal 600 is set between the plug 500 and the Stop/Pause bottom 710. Additional plugs 770 and 780 may are provided for other connection needs, such as a plug only for an earphone and another plug only for an external microphone. The positions of the terminals, plugs and bottoms can be modified for left-handed users, or modified based upon the using habits or preferences of people in different areas of the world.

In addition, different color light sources may be provided on the control face 102 at the triangles 804, 806 to show different operations of the device. For example, a green light on means the devise is on, a red light one means the device is paused, and both green and red lights on and flashing shows the recording is ON. The light source can be LEDs, or the like. The color of lights various depend on consumers' preferences. More than two light sources can be provided on the device. Optionally, the design of the control face 102 can be duplicated to the microphone face 104 for the user's convenience.

The compressed mixture signals can be wirelessly transfer to a display unit of a conventional karaoke system to be played and shown with the lyrics, or to a computer to be sent via the internet and/or a wireless communication network to another user, such as a recorded “Happy Birthday” song or a love song music with the user's own voice, such as, be transmitted to a cell phone to a family member. Such a recorded “Happy Birthday” song or a love song music can be attached to a birthday or greeting e-card. FIG. 12 shows its schematic plot and physical size in blue print format.

In the STAR system, the analog audio signals can be captured under any frequencies and any resolutions. The sampling rate at 44.1 K Hz with 16-bit resolution and stereo channels is widely used for CD quality. In addition, it is more desirable to provide a higher sampling rate such as 48 K Hz in support of the higher quality music such as DVD quality. However, the frequency response of a human voice is under 8 K Hz. It is also significant to provide the sampling frequencies between 44.1 KHz and 8 KHz. Thus, the AD/DA converter in this invention performs a variety of sampling frequencies such as 48 KHz, 44.1 KHz, 22 KHz, 16 KHz, 11 KHz, and 8 KHz. In addition, it also provides different resolutions of audio signals in support of a number of applications. Two key resolutions in audio signals are 8-bit and 16-bit, which both are provided in the AD/DA converter in the invention of the STAR system.

The invention can be applied for e-Language tutoring. In this STAR system, the language learner/student can speak with the tutor, which is pre-recorded in the SD memory (the external memory device). The learner/student speaks and simulates the same tone, pronunciation, and accent until totally matching with the recording of the tutor. With regular practice, students can speak languages just like a tutor, such as a native language speaker.

Beside human voice, sounds made by other lives in beings, such as dogs, cats, horses, birds, bugs, wolves, whales, tigers, etc., or non-lives, such as waterfalls, rains, winds, thunderstorms, trains, etc., can also be mixed with pre-recorded voice, sound, or music.

The principles, preferred embodiments and modes of operation of the present invention have been described in the foregoing specification. However, the invention that is intended to be protected is not limited to the particular embodiments disclosed. The embodiments described herein are illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A hand-held audio mixing device comprising:
an audio I/O interface;
an AD/DA converter;
a dual-direction audio codec which sample rate is set in a range of 8-48 K Hz with a 16-bit resolution;
a MicroController Unit (MCU);
a memory; and
an operational amplifier,
wherein said device executes a first process that the audio I/O interface receives a first source of analog audio signals, and the operational amplifier amplifies said received first source of analog audio signals thereby playing the amplified first source of analog audio signals to a user,
wherein said device executes a second process that the audio I/O interface receives a second source of analog audio signals, the AD/DA converter mixes said received second source of analog audio signals with the amplified first source of analog audio signals into an analog mixture, the AD/DA converter converts said analog mixture into digital mixture signals, the dual-direction audio codec compresses the digital mixture signals, and the memory saves the compressed digital mixture signals, and
wherein the first and second processes are executed substantially simultaneously such that there is no latency delay perceivable by the user.

2. The hand-held audio mixing device according to claim 1, wherein the first source of analog audio signals are pre-recorded on an external storage medium.

3. The hand-held audio mixing device according to claim 2, wherein the external storage medium is a CD, a CDG Karaoke disc, a VCD, or a DVD, and the audio I/O interface includes an input terminal for receiving analog audio signals from a CD, CDG Karaoke, VCD, or DVD player.

4. The hand-held audio mixing device according to claim 2, wherein the first source of analog audio signals are voice, sound, or music.

5. The hand-held audio mixing device according to claim 1, wherein the second source of analog audio signals are voice, sound, or music.

6. The hand-held audio mixing device according to claim 1, wherein the audio I/O interface includes a built-in microphone for receiving at least the second source of analog audio signals, and an earphone for playing the amplified depressed first source of analog audio signals.

7. The hand-held audio mixing device according to claim 1, wherein the first source of analog audio signals are music and the second source of analog audio signals are human voice so as to provide a karaoke function.

8. The hand-held audio mixing device according to claim 1, further comprising a digital I/O interface.

9. The hand-held audio mixing device according to claim 1, wherein the digital I/O interface supports at least one of USB, Ethernet, and firewire connections.

10. The hand-held audio mixing device according to claim 8, further comprising an external storage medium stored with a first source of digital audio signals.

11. The hand-held audio mixing device according to claim 10, wherein the external storage medium is a Secure Digital (SD) card, a memory stick, a SmartMedia (SM) card, or a Multimedia Card (MMC), and the digital I/O interface includes an input terminal for receiving said first source of digital audio signals from the external storage medium.

12. The hand-held audio mixing device according to claim 11, wherein said first process use the digital I/O interface to receive a first source of digital audio signals instead, the dual-direction audio codec decompresses said received first source of digital audio signals into decompressed first source of digital audio signals, the AD/DA converter converts the decompressed first source of digital audio signals into decompressed first source of analog audio signals, and the operational amplifier amplifies said decompressed first source of analog audio signals thereby playing the amplified depressed first source of analog audio signals to a user.

13. The hand-held audio mixing device according to claim 8, wherein the memory is stored with a first source of digital audio signals.

14. The hand-held audio mixing device according to claim 13, wherein the first source of digital audio signals are pre-recorded during manufacturing process or imported via the digital I/O interface by a user.

15. The hand-held audio mixing device according to claim 13, wherein said first process use the digital I/O interface to receive a first source of digital audio signals instead, the dual-direction audio codec decompresses said received first source of digital audio signals into decompressed first source of digital audio signals, the AD/DA converter converts the decompressed first source of digital audio signals into decompressed first source of analog audio signals, and the operational amplifier amplifies said decompressed first source of analog audio signals thereby playing the amplified depressed first source of analog audio signals to a user.

16. The hand-held audio mixing device according to claim 10, wherein the dual-direction audio codec complies with JPEG2000.

17. The hand-held audio mixing device according to claim 1, further comprising a star-shaped case for accommodating the audio I/O interface, the AD/DA converter, the dual-direction audio codec, the MCU, the memory, and the operational amplifier therein.

18. The hand-held audio mixing device according to claim 17, wherein the star-shaped case has a front face, a back face and five triangular side faces,
wherein connection terminals and control bottoms are arranged on the five triangular side faces.

19. The hand-held audio mixing device according to claim 17, wherein the star-shaped case has a front face, a back face and five triangular side faces,
wherein connection terminals are arranged on the five triangular side faces, and control bottoms are arranged on at least one of the front face and the back face.

20. The hand-held audio mixing device according to claim 17, wherein the star-shaped case has a front face, a back face and five triangular side faces, and at least one light source is provided on the front face, the back face, or one of the five triangular side faces to indicate operation states of the device.

21. An audio mixing system comprising:
an audio/video display unit;
a main unit operably connected with the display unit though a wire or by wireless so as to feed said display unit with image data for displaying words of a music piece on said display unit; and
a hand-held audio mixing device, wherein
the hand-held audio mixing device includes an audio I/O interface, an AD/DA converter, a dual-direction audio codec which sample rate is set in a range of 8-48 K Hz with a 16-bit resolution, a MicroController Unit (MCU), a memory, and an operational amplifier,
wherein said device executes a first process that the audio I/O interface receives a first source of analog audio signals, and the operational amplifier amplifies said received first source of analog audio signals thereby playing the amplified first source of analog audio signals to a user,
wherein said device executes a second process that the audio I/O interface receives a second source of analog audio signals, the AD/DA converter mixes said received second source of analog audio signals with the amplified first source of analog audio signals into an analog mixture, the AD/DA converter converts said analog mixture into digital mixture signals, the dual-direction audio codec compresses the digital mixture signals, and the memory saves the compressed digital mixture signals, and
wherein the first and second processes are executed substantially simultaneously such that there is no latency delay perceivable by the user.

22. The audio mixing system according to claim 21, wherein the main unit also control the display unit to display lyrics of a music piece thereon.

23. The audio mixing system according to claim 21, further comprising a microphone.

24. An audio mixing method comprising:
providing a hand-held audio mixing device which includes an audio I/O interface, an AD/DA converter, a dual-direction audio codec, a MicroController Unit (MCU), a memory, and an operational amplifier,
executing a first process including: receiving by the audio I/O interface a first source of analog audio signals, and amplifying by the operational amplifier said received first source of analog audio signals thereby playing the amplified first source of analog audio signals to a user,
executing a second process including receiving by the audio I/O interface a second source of analog audio signals, mixing by the AD/DA converter said received second source of analog audio signals with the amplified first source of analog audio signals into an analog mixture, converting bye AD/DA converter said analog mixture into digital mixture signals, compressing by the dual-direction audio codec the digital mixture signals, and saving by the memory the compressed digital mixture signals, and
wherein the first and second processes are executed substantially simultaneously such that there is no latency delay perceivable by the user.
